(19) United States
(12) Patent Application Publication
(10) Pub. No.: US 2009/0001764 A1
(43) Pub. Date: Jan. 1, 2009

(54) Vehicle Chassis

(75) Inventors: Reuben Hoppenstein, New Rochelle, NY (US); Robin D. Day, Kent (GB)

Correspondence Address: KEITH D. NOWAK, CARTER LEDYARD & MILBURN LLP, 2 WALL STREET, NEW YORK, NY, 10005, US

(73) Assignee: Cocky Coach LLC, New York, NY (US)

(21) Appl. No.: 10/572,411

(22) PCT Filed: Nov. 8, 2005
(86) PCT No.: PCT/US05/40349

§ 371 Date: Oct. 4, 2007

Related U.S. Application Data
(60) Provisional application No. 60/661,919, filed on Mar. 16, 2005.

(51) Int. Cl. B62D 31/00; B62D 33/08; B60B 11/00; B60F 3/00

(52) U.S. Cl. 296/203.01; 296/26.08; 301/36.1; 440/12.51

(57) ABSTRACT

A self propelled conveyance is disclosed having an extendable frame. A floor pan is attached to the inner perimeter of the extendable frame and a driver's seat is disposed on a front to back center line of the floor pan. A pair of front wheels are attached to the extendable frame. The front wheels extend beyond the outer perimeter of the frame. A rear wheel assembly is one or two individual wheels separated by a short distance. Like the front wheels, the rear wheel assemble extends beyond the outer perimeter of the frame. Passenger seats are disposed behind the driver seat and each of the passenger seats are offset from the center line of the conveyance. Because the wheels extend beyond the perimeter of the frame, they act as active collision shock absorbers in collisions.

### CROSS REFERENCE TO RELATED APPLICATIONS

This application claims priority to U.S. Provisional Application No. 60/661,919, filed Mar. 16, 2005; and PCT/US2005/040349, filed Nov. 8, 2005, the entirety of both are incorporated herein by reference.

### FIELD OF THE INVENTION

The present invention relates to light-weight vehicles and more particularly to a lightweight vehicle with improved safety features.

### BACKGROUND OF THE INVENTION

U.S. Pat. No. 4,217,970 to Chika, issued Aug. 19, 1980 discloses and claims a configuration and construction of four-wheeled motor vehicles. It is indicated, at column 2, lines 9-21 of the patent, that an objective is to create entirely new type of motor vehicle by producing rigid left and right vehicle sides using either tubular construction or large, specifically reinforced stampings or molded panels of synthetic materials and transversely interconnecting them by the torsionally resilient members to create a light vehicle chassis and body structure and covering the spaces between thus interconnected sides with hood, roof and trunk panels of any suitable materials to enclose and protect thus configured body from elements and pilferage as is presently done with existing motor vehicles.

U.S. Pat. No. 6,017,084 to Carroll et al, issued Jan. 25, 2000 describes an energy absorbing lattice for incorporation within automotive vehicle body panels. The objective of the Carroll invention is to improve crash test performance and passenger safety and yet permit elimination of much of the conventional frame and passenger cage commonly utilized to support and protect the vehicle's occupants. According to the Carroll concept, a reinforcing energy absorbing member is laminated to the inner face of a “contact surface” (automobile body panel) in a manner and configuration calculated to optimize absorption/dissipation of impact energies to the contact surface. The reinforcing energy absorbing member, unlike the so-called crush boxes typically found in bumpers, is composed of an interconnected lattice of a molded or fabricated mass of steel, plastic, or composite thereof, which defines a plurality of cells. The foregoing configuration reportedly enhances the crash worthiness of the vehicle, thus, permitting reduction in size and in some cases elimination of energy absorbing pillars and headrails.

U.S. Pat. No. 6,010,182 (to Townsend et al, issued Jan. 4, 2000), describes a unique chassis and body panel combination for various conveyances, e.g. cars, boats, aircraft and personal “people power vehicles” (also PPV). The Townsend “system” utilizes a module or spaceframe and body panel wherein each of the frame and panels has complimentary fittings to firmly engage the panel to the frame. The complimentary fittings are releasable, to allow for change or replacement of a given panel; or to allow for change or replacement of all, or a group of panels, so as to modify the utility or appearance of the vehicle. The Townsend module or spaceframe closely resemble the traditional unibody vehicle construction, through its utilization of a series of welded pillars and posts to define a passenger and engine compartment. The Townsend invention, reportedly represents a substantial improvement in ease of vehicle manufacture, without sacrifice in structural stiffness and durability of the frame. Moreover, the design freedom afforded by the Townsend invention also reportedly permits for improved passenger safety through such enhancements in the design of the car body frame.

U.S. Pat. No. 6,719,364, issued Apr. 13, 2004, (Hoppenstein) disclosing a light weight, three-wheeled vehicle, for three passengers, with the integration of three or more vertical and horizontal chassis beams and roll bars for maximum safety and with minimal risk of compressing the cage during accidental impact the entirety of which is incorporated herein by reference. The enclosing panels are constructed of light weight plastic, fiberglass or composites, will protect the passengers.

Notwithstanding the strides made in the prior art, including those specifically referenced and discussed herein, there is a continuing need to further enhance passenger safety, without compromise of fuel economy or added expense. To the extent that each of the Chika, Carroll and Townsend concepts have made certain strides in that direction, each is limited by introduction of complexities that require relatively substantial departures from traditional manufacturing process and materials, and, thus, have not been adopted to any substantial degree. Moreover, while each of the directions taken by Chika, Carroll and Townsend to improve vehicle performance and manufacture, are laudable, they appear to be impractical for application to problems associated with personal conveyance of large populations of individuals at relatively modest cost approaching that of public transportation.

### SUMMARY OF THE INVENTION

This disclosed vehicle is safer, more economical to purchase and operate, and recyclable. Because of its smaller size, it would help to alleviate city street and parking congestion.

In order to make this vehicle environmentally friendly, many parts are recyclable and others are long lasting and easily replaceable. In its entirety, it is a down sized vehicle, a cross between a motor cycle and a car, an “Automoto™”. Internationally, a three-wheeler is classified as a motorcycle.

In the present specification, we describe unique features in the further development of a vehicle chassis.

1) The chassis, roll bars, and skeleton are preferably constructed of stainless steel to reduce the weight of the frame, strengthen the frame, and create a frame that is long lasting by avoiding corrosion.

2) The two front wheels and the rear single wheel assembly, all project outside the limits of the vehicle body. The pneumatic tires act as active collision shock absorbers, and in a front or rear end collision, will absorb the impact. (FIG. 1)

3) The rear wheel suspension is stationary or mechanically rotatable to achieve full or partial rotation of the vehicle on its own foot print. To allow for a more compact parking envelope the front wheels rotate in the opposite direction of the rear wheel assembly thus decreasing the turning circle. (FIG. 2)

4) The rear wheel can be mounted on a rotatable platform and can be rotated either mechanically or by hydraulic means. (FIG. 2)

5) The present invention can be elongated to accommodate 3 or more passengers by lengthening the chassis and adding additional roll bars for safety. (A taxi, truck, delivery van or bus, can be created by elongating the chassis and, modifying the body.) (FIG. 3)

6) The preferable configuration is for a three passenger vehicle. The driver is seated ahead of the two passengers seated slightly to the rear. This allows for a world vehicle, drivable either on the right or the left side of the road. (FIG. 4)

7) By placing the driver ahead of the two passengers, the broadest part of the human anatomy, the shoulders, overlap those of the driver so that a narrower cage is possible. (FIG. 4)

8) The rear third wheel can be two similar wheels separated by a short distance on the same axle. This dual wheel would still be considered as a third wheel. (FIG. 5)

9) For recreational or military uses, this vehicle could have the dual rear wheels act as a water jet propulsion system for crossing streams and rivers, without having to disengage the wheels and engage a propeller. (FIG. 6)

10) The spokes of the rear wheels will be constructed to act as propellers driving the water medially into a compression chamber straddling the space between the two wheels. A conical nozzle will direct the water (jet) stream posteriorly, driving the vehicle forward. (FIG. 7)

11) In event of a flat (punctured tire), in the case of one the double rear wheels, the vehicle can still proceed normally as the chassis is sturdy. In the case of a front wheel being deflated, this wheel can be exchanged with one of the rear ones. This obviates the need for having a spare tire in an already diminished sized cabin. (FIG. 10)

12) Because of its light weight, economy of purchase, sturdiness and operation, this becomes a rapid means of deployment for the military. This vehicle could be dropped by parachute together with parachutists, and then abandoned at minimal cost when the troops reach their destination.

13) Out board rear view mirrors usually mounted on the sides of vehicles, increase the drag or wind resistance by 7-9%, thereby reducing the gas economy of the vehicle by an equal amount. To counter this, three tiny digital cameras will be mounted on both outer surfaces of the “a” pillar, and a third on the back of the vehicle horizontal roll bar.

14) Three small LCD displays will be mounted side by side on the dash board in front of the driver. The side cameras will also show part of the vehicular side wall, giving the driver an instant orientation of the position of the approaching or passing object. (FIG. 12). This concept has been named as rearama O.

15) In the previous patent, we described an exoskeleton, these bars can be clad or finished in the more expensive models to reduce drag or for beautification.

16) In the midpoint of the upper roll bar, provision will be made for an accessory screw-in steel eye for hoisting this light weight vehicle in a garage, onto a yacht or truck, or for repairs.

17) The highest point of the upper roll bar can have a string of LED's or bulbs on the front and back surfaces. Those on the front will be yellow and those on the rear red. These diodes will glow brighter when the driver applies the brakes. This is a safety feature to alert other drivers both in front and rear of the vehicle that the brakes are being applied and inform other drivers of slowing or stopping. The yellow lights will be seen by the driver of the car ahead in his rear view mirror.

18) A stripped down, more economical version, a “run-a-round”, the X-O SKELTON™, the steel roll bars are exposed and two trunks are created, front and rear which will be large storage spaces with molded removable cases that will fit the spaces to maximize their storage capacity and practicability. The rear container is large enough to hold a soft convertible top. Each of the storage means can have form-fitted cases or a plurality of cases to fit each space.

19) The engine can be placed in front, mid-body or in the rear of the vehicle. The engine can be gas, diesel, electric, or the like.

20) An overhead customized roof storage space is designed to minimize drag and can be easily mounted and attached on the “a” and “b” pillar roll bars and can also serve as a roof.

21) With the two rear seats removed, a small delivery truck, golf cart, etc can be created.

22) By extending the chassis, a 5, 7, or 9 or more “seater” taxi or mini bus can be created. (FIG. 3)

23) Assembly of the entire vehicle can be done using a robotic assembly. The individual chassis pieces are placed in welding jigs to hold the pieces in place. Subsequently, automatic welding can occur.

24) When the vehicle is being used in an amphibious mode, flotation devices would be fitted in the walls or the roll bar.

25) In yet another embodiment, an electric engine is used and the roof of the vehicle is comprised of solar panels to power the motor and charge a storage battery.

26) In another embodiment of the invention, the front wheels extend past the sides of the vehicle six to act as a side bumper as well as a front bumper.

### SUMMARY OF THE FIGURES

FIG. 1 shows one embodiment of a vehicle according to the invention including impact points on protruding tires;

FIG. 2 depicts the turning mechanism of the vehicle;

FIG. 3 depicts a vehicle according to the present invention including an upper roll bar and points where the chassis could be extended;

FIG. 4 depicts the seating positions in a vehicle according to one embodiment of the invention;

FIG. 5 is a front view of a rear assembly according to the present invention;

FIG. 6 is a side view of rear wheel including the manner in which the impeller functions;

FIG. 7 is a side view of rear wheel assembly and baffles between the two wheels that direct the water backwards towards the nozzle;

FIG. 8 depicts an embodiment of the amphibious vehicle;

FIG. 9 depicts an amphibious propulsion system;

FIG. 10 depicts a scenario for repairing a flat front tire where an inflated back wheel is rotated to the flat front wheel position;

FIG. 11 depicts signaling LED's on an upper roll bar;

FIG. 12 depicts three screens mounted in front of driver, showing a panoramic view of the rear of the vehicle from rear facing cameras; and

FIG. 13 depicts the storage area of the vehicle according to one embodiment of the invention.

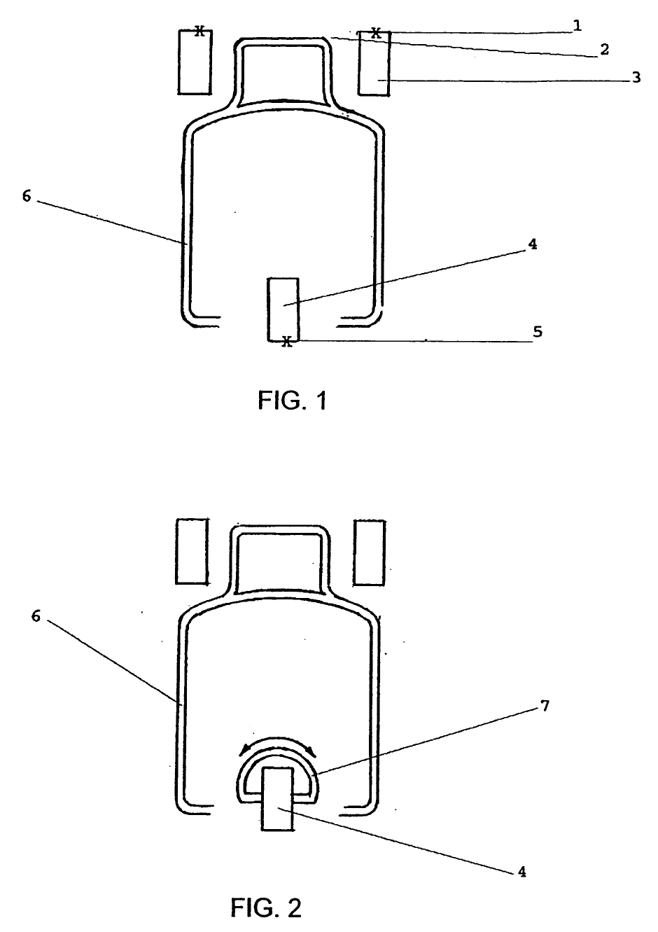

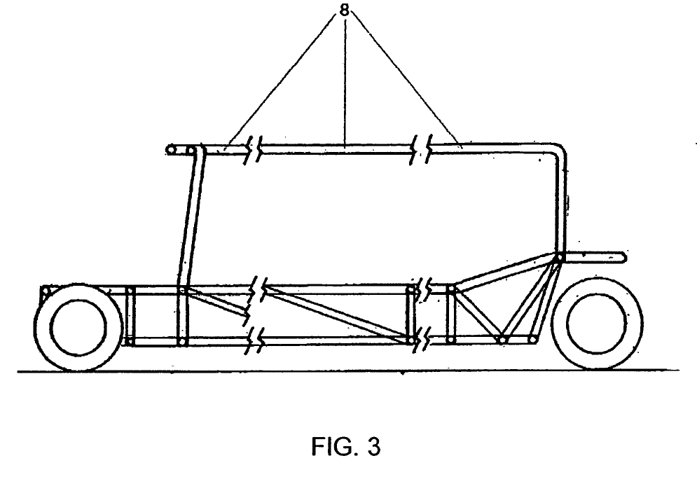

### DETAILED DESCRIPTION OF THE INVENTION

FIG. 1 depicts a vehicle according to the present invention. As shown, the tires of the vehicle extend beyond the outer perimeter of the body of the vehicle. In particular, the front wheels 3 extend past the front of the vehicle 2. In one embodiment of the invention, the front wheels 3 also extend beyond the side of the chassis 6. The rear wheel 4 also protrudes from the back of the vehicle to providing a rear impact point. The tires provide impact points 1 and 5. The protruding tires effectively provide front and rear bumpers for the vehicle. In a preferred embodiment, the vehicle is steered using both the front and rear wheels. Alternatively, the steering is user selectable, i.e., the front wheels, the rear wheels, or both sets of wheels can be used for steering. The steering can be accomplished using hydraulics, mechanical linkages, or a combination of both.

In one embodiment, the vehicle has a frame that includes a roll cage and a floor pan, for defining a compartment for carrying passengers and a power plant. The frame comprises at least two substantially elliptical roll bars and the floor pan, or alternatively, a plurality of polygon shaped roll bar assemblies and a floor pan. In one embodiment, the roll bars are constructed using a lattice-like construction, thereby increasing the strength of the roll bars. One of the horizontally disposed roll bars is integrally bonded to the floor pan at the perimeter of the floor pan. At least one additional roll bar positioned inboard of the horizontal roll bars and at an inclined angle relative to said floor pan. The horizontal roll bars are connected to the inclined roll bar at each intersection point. The front wheels 3 and the rear wheels 4 are exposed and extend beyond the outer perimeter of the elliptical roll bars to form bumpers.

In a preferred embodiment, to reduce drag, approximately 90% of the air travels over the top of the vehicle. The remaining air is channeled under the vehicle or down the side of the vehicle. In a preferred embodiment, a portion of the air is used for cooling the motor, radiator, brake rotors, and the like.

The vehicle is steered by rotating rear assembly 7. The vehicle can also use front steering. However, the vehicle uses rear steering or jet propulsion in amphibious mode. Rear steering with front steering provides a smaller turning radius than conventional front steering vehicles.

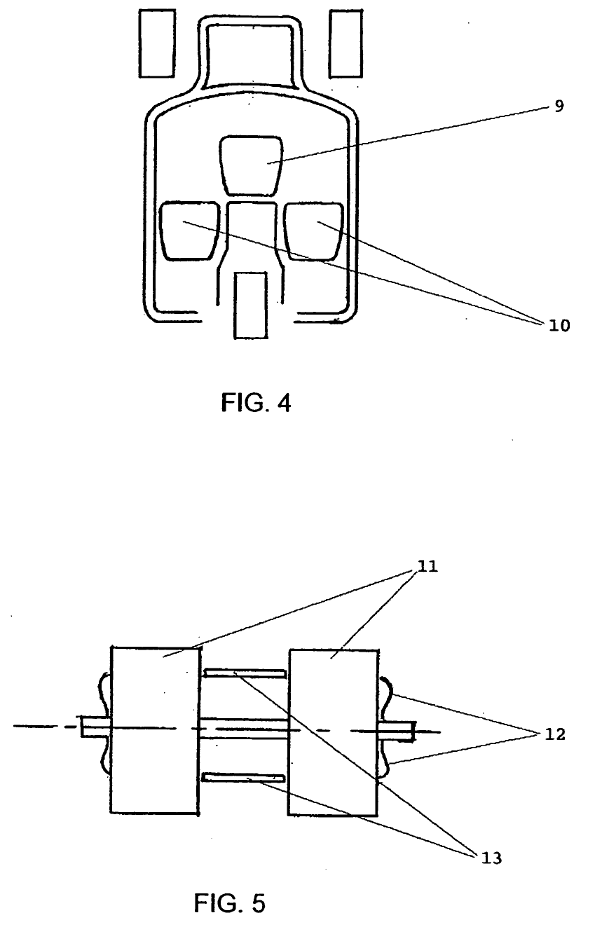

FIG. 3 is a depiction of the vehicle according to one embodiment of the invention. As shown, the frame includes a roll bar 8. In a preferred embodiment, the frame has a length appropriate to accommodate three seats, as discussed further below.

As shown in FIG. 3, the frame and roll bar are extendable to accommodate additional seating. Without adding additional wheels, the chassis can be extended to accommodate 5 or more seats. The extended chassis can be used as a taxi, bus, or the like. Because the frame is preferably constructed from stainless steel or an equivalent, it is strong enough to be extended.

In one embodiment, the frame includes at least two essentially D-shaped roll bars and a floor pan. One horizontally disposed roll bar is integrally bonded to said floor pan at the perimeter thereof, and at a second roll bar is positioned inboard of said horizontal roll bars and at an inclined angle relative to said floor pan. The horizontal roll bar is connected to the inclined roll bar at each intersection point forming an exoskeleton around the compartment. The tires extend beyond the perimeter of the exoskeleton. This creates a non-compressible occupant compartment of a rigid, unified structure with additional protection.

In another embodiment, the frame is formed using a lattice-like structure as shown in FIG. 3. In this embodiment, the frame and roll bar are formed to create the occupant compartment. The tires protrude beyond the perimeter of the vehicle to act as bumpers providing additional protection.

FIG. 4 is a top view of the vehicle according to one embodiment of the invention. Shown is the seating position according to one embodiment of the invention. The driver sits mid-frame in position 9 and passengers sit in the back in seats 10. Additional seats are added behind seats 10. The disclosed vehicle is drivable in both right-hand drive and left-hand drive countries without modification because the driver sits approximately in the middle of the vehicle. In one embodiment, there is a storage area between the front wheels. Additionally, as shown, the tires extend beyond the perimeter of the frame.

In one embodiment, the vehicle is designed for dual use, both dry land and marine applications. The vehicle requires a dual propulsion and steering system when used in a marine environment. This system is described as “Hydro Jet Steering and Drive.”

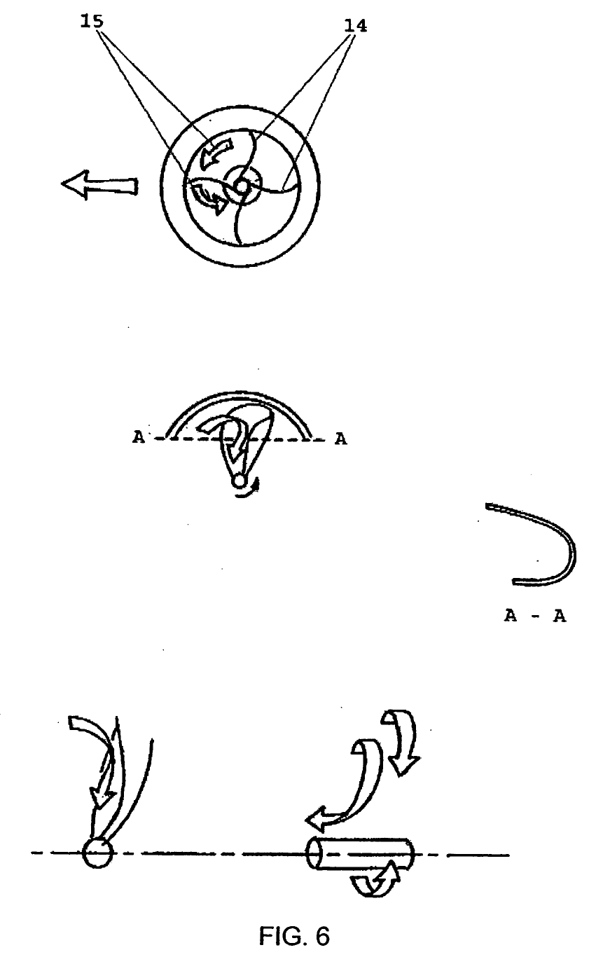

As shown in FIG. 5, the rear wheel is preferably two wheels separated by a short axle. Each wheel hub has protruding spokes 12. These spokes 12 act as paddle wheels when the vehicle is operated in amphibious conditions. Between the two wheels are baffles 13 that direct water between the two wheels and direct it backwards. As seen with more detail in FIG. 6, impeller 14 scoops and forces water in direction 15. The protruding spokes direct the water medially towards the impeller 14. The configuration of the wheels creates a vertical propeller to propel the vehicle in water.

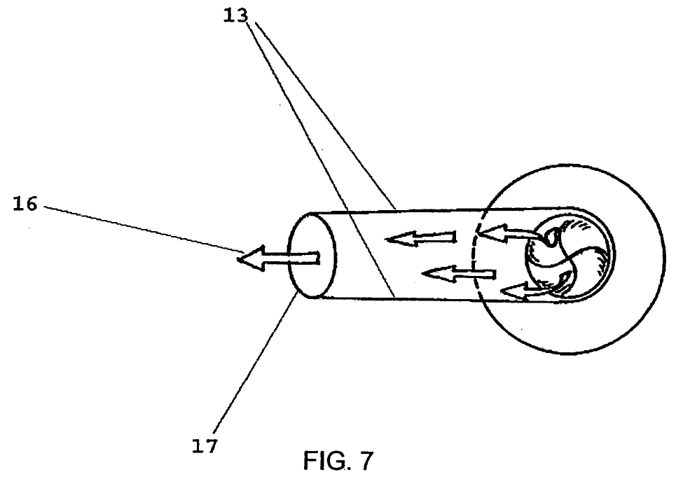

As shown in FIG. 7, the baffles 13 direct the water. In one embodiment, a nozzle 17 further directs the water. The nozzle 17 is affixed to the rear wheel assembly so that it moves with the assembly. In other words, the steering wheel that controls the rear wheel also controls the nozzle. Alternatively, the nozzle is separate from the wheel assembly but is controlled by the steering wheel. The nozzle increases the force of the water to propel the vehicle.

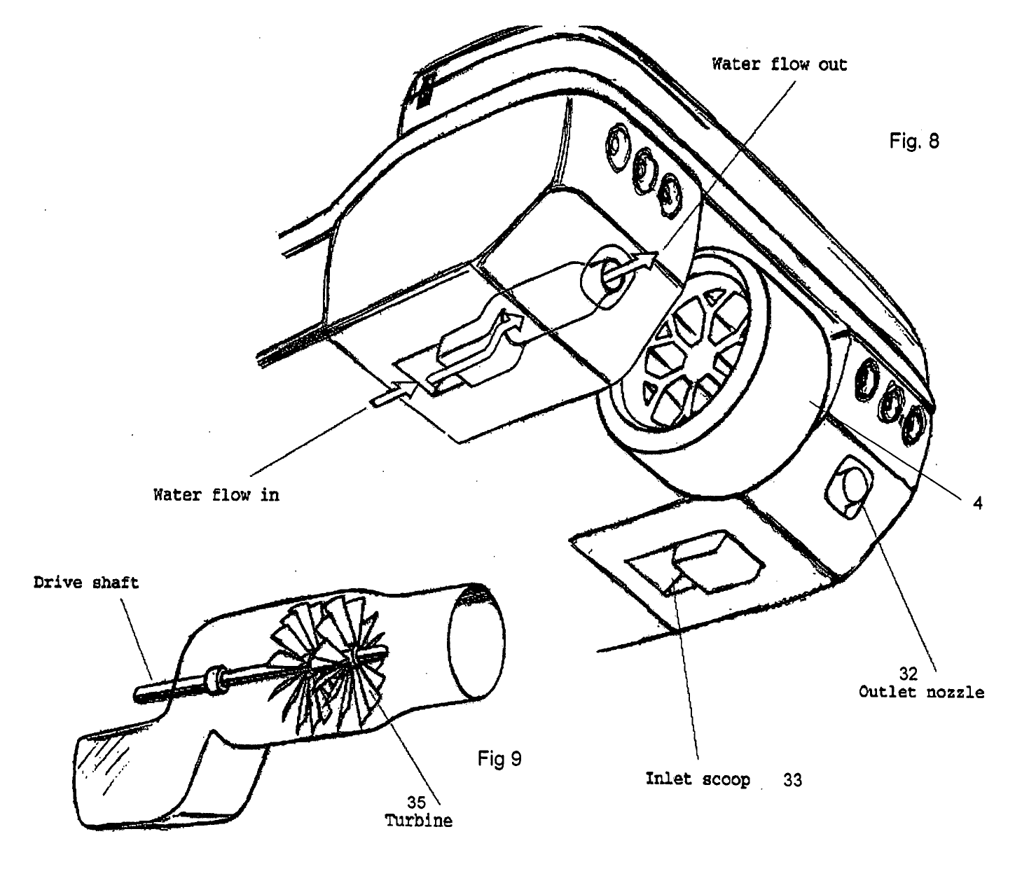

As shown in FIG. 8, in another embodiment of the amphibious propulsion system, instead of having two paddle wheels on a short axle creating a water jet, the regular broad back wheel or double wheel 4 is retained and two water jets 30 and 31, one in each rear quarter of the vehicle is used. The water jets provide propulsion when in water. Water jets, such as those typically used on jet skis would allow for more rapid propulsion.

This double set of water jet engines would also allow for steering the vessel by decreasing the speed of one water jet to turn the vehicle to one side or the other. In one embodiment, two throttles, as used in motor boats, situated in front of the driver on the dashboard control the water jets. In an alternative embodiment, sensors in the steering wheel control the water jets such that turning the steering wheel causes higher or lower output to the water jets. Alternatively, rudders are used to steer the vehicle.

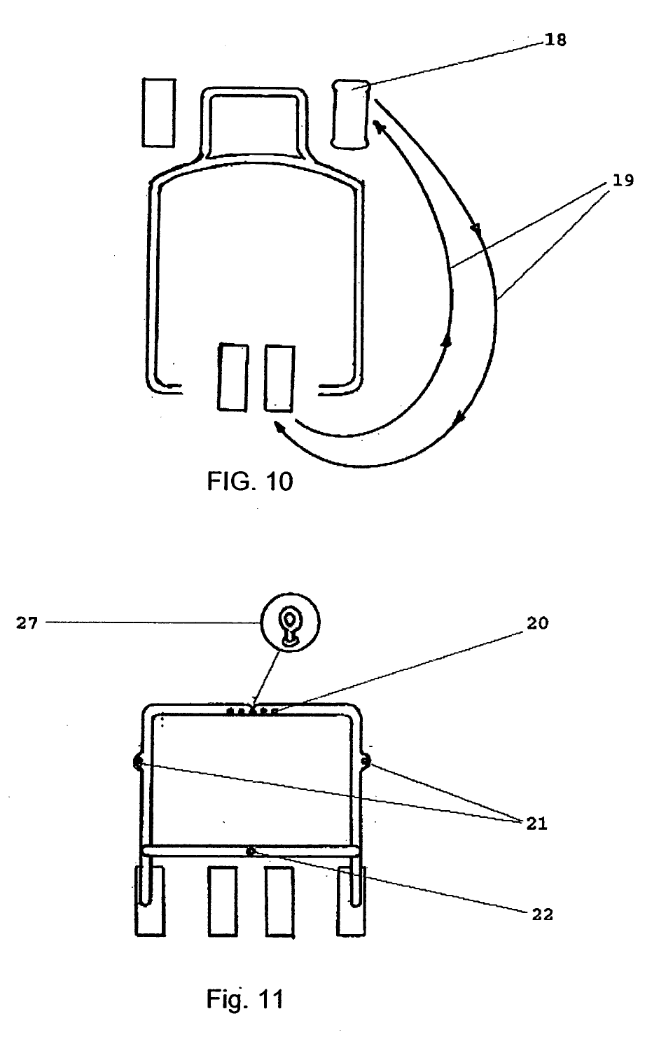

As shown in FIGS. 8 and 9, dual turbine or impeller type submersible drive units 35 pull in water from the underside of a vehicle 33 and evacuate that material, now energized, via an exhaust passage 32. Water inlet 33 preferably remains closed during normal operation to reduce drag, only opening in amphibious mode. Hydraulic or electric motors provide a power source for turbines. In a preferred embodiment, the drivetrain includes a transfer case or transmission adapted to transfer power from the drive wheels to the water propulsion means. The pressurized fluid is forced back to its source which will oppose the pressure and move the vehicle in the opposite direction.

The vehicle's steering system is coupled to a proportional valve (hydraulic) or rheostat (electric) which controls the speed of individual motors fitted to the rear underside of the vehicle and effects steering by reducing the speed and pressure applied to one side of the vehicle while increasing the speed and pressure to the opposite side. In another embodiment, a mechanical system is used. The mechanical system increases or reduces the inlet aperture. The effect of the fluid speed increase and opposite reduction of fluid speed causes the vehicle to turn while making forward motion. While traveling in the opposite direction, the motors can be reversed and steering can be effected in precisely the same way.

A unique feature of the vehicle is shown in FIG. 10. If one of the rear tires becomes flat, the vehicle rides on the remaining tire without a significant loss of performance. If one of the front tires 3, 18 becomes flat, one of the inflated rear tires is swapped with the flat front tire. The vehicle can continue until the flat tire is repaired. Because there are two tires in the rear of the vehicle in close proximity to one another, one tire can be flat while the vehicle travels on the remaining tire. Alternatively, the flat tire can be stored in one of the vehicle's storage areas 28, 29, or mounted on the roof 30.

FIG. 11 is a rear view of the vehicle. In one embodiment, there are LEDs, bulbs, fiber optics, or other lighting device 20 on the roll bar. In other embodiments, the lighting device is on another rear facing portion of the vehicle. In one embodiment, there is a matching set of lighting devices in the front of the vehicle. Preferably, the front facing lighting devices are yellow and the rear facing lighting devices are red. Both the front and rear lighting devices get brighter when the driver depresses the brake peddle. The brightening of the lighting devices alerts surrounding drivers of an impending stop. The front lighting devices also alert pedestrians in crosswalks and the like that the vehicle is braking.

Lifting hooks 27, as shown in FIG. 11, are provided on the roll bar. The lifting hooks can be used to lift the vehicle onto a truck or boat for transport or to lift the vehicle to work on it in a shop. The lifting hooks can also be used in air-lift applications to load the vehicles onto planes or large helicopters. Additionally a parachute can be attached to the hooks 27. The vehicle is light-weight enough to drop by parachute and strong enough to survive a drop by parachute.

The vehicle has at least one rear mounted camera. The camera can be a CCD camera, a digital or analog camera, or the like. Preferably there are at least two cameras one each side of the vehicle, and one in the rear of the vehicle that provide a 180 degree view of the rear of the vehicle. The two side cameras can have wide angle lenses to further eliminate blind spots.

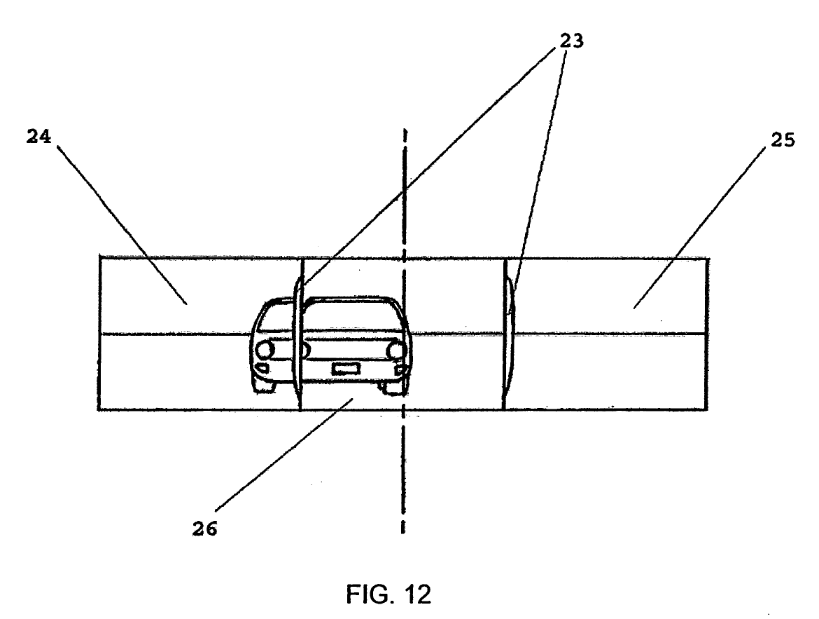

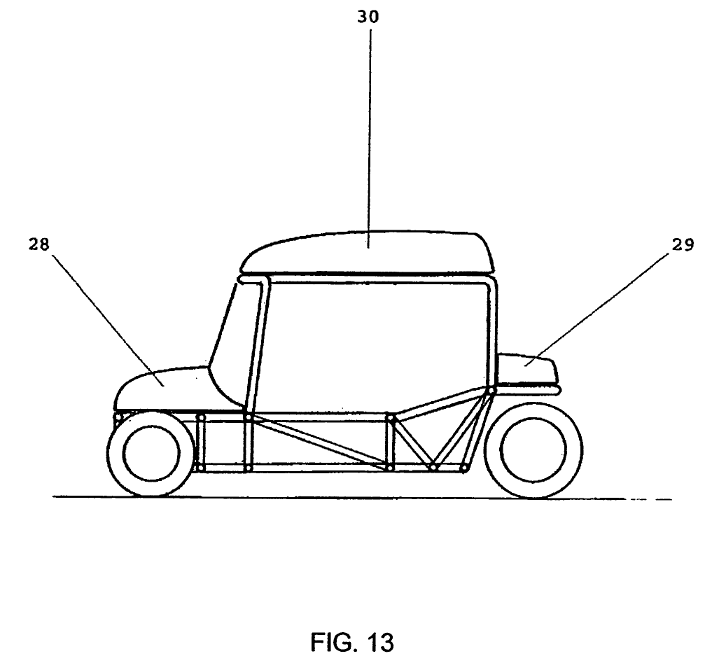

As shown in FIG. 12, three screens 24, 25, and 26 are mounted in front of the driver, providing a panoramic view of the rear from cameras 21 and 22. Cameras 21 are mounted on the sides of the vehicle. The third camera 22 is mounted on the midline on the rear of the vehicle. Preferably screen 26 is larger and dedicated to display the view from camera 22. The screens 24 and 25 show the side of the vehicle to assist the driver in determining the location of other cars, pedestrians, or the like. The screen can be one or a plurality of screens. The screens can be LED displays, LCD displays, plasma screens, CRT displays, touch screen, a heads-up display, or the like. In one embodiment, one of the screens switches from rear display to a GPS display and the remaining two screens display the panoramic view of the rear of the vehicle. Further, one of the screens can switch to display climate control, radio control, and the like. Preferably, the screen used for additional displays is screen 26.

FIG. 13 shows possible storage locations for the vehicle. In one embodiment the vehicle preferably has a front, rear, and roof trunk. The front trunk 28, the rear trunk 29, and the roof trunk 30 each have luggage matching the shape of the trunk to maximize storage. The luggage may be only a portion of the respective trunk. For example, there may be three pieces of fitted luggage for the roof trunk, each being a third of the trunk. These smaller pieces of luggage would be more maneuverable than one large piece of luggage.

While this invention has been described by reference to preferred embodiments, it should be understood that numerous changes could be made within the spirit and scope of the inventive concepts described. Accordingly, it is intended that the invention not be limited to the disclosed embodiment, but that it have the full scope permitted by the language of the following claims.

We claim:

1. A self propelled conveyance comprising:
an extendable frame having an inner and outer perimeter;
a floor pan attached to the inner perimeter of the extendable frame;
a driver seat disposed on a front to back center line of the conveyance;
a pair of front wheels attached to the extendable frame, the front wheels extending beyond the outer perimeter of the frame; and
a rear wheel assembly, the rear wheel assembly being at least one wheel, the rear wheel assemble extending beyond the outer perimeter of the frame.

2. The self propelled conveyance of claim 1, further comprising:
a plurality of passenger seats, the passenger seats disposed behind the driver seat and each of the passenger seats being offset from the front to back center line of the conveyance.

3. The self propelled conveyance of claim 2, wherein the wheels are pneumatic tires and act as active collision shock absorbers in a frontal or rear end collision.

4. The self propelled conveyance of claim 1, wherein the rear wheel assembly further comprises two individual wheels separated by a short distance,

5. The self propelled conveyance of claim 1, wherein the rear wheel assembly further comprises:
two wheels separated by a short axle, each wheel being mounted on a hub, the hubs each having protruding spokes, wherein
the spokes act as paddle wheels when the self propelled conveyance is operated in amphibious conditions.

6. The self propelled conveyance of claim 5, wherein the rear wheel assembly further comprises: at least one baffle located between the two rear wheels to direct water.

7. The self propelled conveyance of claim 6, wherein the rear wheel assembly further comprises:
a conical nozzle to direct the water posteriorly, driving the self propelled conveyance.

8. The self propelled conveyance of claim 3, further comprising:
a plurality of digital cameras mounted on the rear of the vehicle at least one of said plurality of digital cameras being mounted on a horizontal roll bar; and
a plurality of displays mounted on a dash board in front of the driver seat, the displays displaying at least a view from the plurality of digital cameras.

9. The self propelled conveyance of claim 8, wherein at least one digital camera and display shows part of a self propelled conveyance sidewall, giving an instant orientation of a position of an approaching or passing object.

10. The self propelled conveyance of claim 9, wherein at least one of the plurality of displays is adapted to toggle between the view from the digital camera and a GPS display.

11. The self propelled conveyance of claim 3, further comprising:
an accessory steel eye for hoisting the self propelled conveyance, the steel eye being installed in an upper portion of the self propelled conveyance.

12. The self propelled conveyance of claim 3, further comprising:
a string of illuminating devices on a front and back surface, the illuminating devices on the front surface being yellow and the illuminating devices on the rear surface being red, wherein
the illuminating devices are activated by braking the self propelled conveyance.

13. The self propelled conveyance of claim 3, further comprising:
an electric engine; and
solar panels mounted on the roof of the self propelled conveyance to power the electric and charge a storage battery.

14. A method of changing a flat tire on a vehicle having a double rear tire comprising:
removing one of the inflated rear tires;
removing the flat tire and replacing it with the removed inflated rear tire.

15. The method of changing a flat tire of claim 14, further comprising:
installing the flat tire in place of the removed inflated rear tire.

16. A self propelled conveyance comprising:
an extendable frame having an inner and outer perimeter;
a floor pan attached to the inner perimeter of the extendable frame;
a driver seat disposed on a front to back center line of the conveyance;
a pair of front wheels attached to the extendable frame, the front wheels extending beyond the outer perimeter of the frame;
a rear wheel assembly, the rear wheel assembly being two individual wheels separated by a short distance, the rear wheel assemble extending beyond the outer perimeter of the frame; and
two water jets, one in each rear quarter panel for amphibious propulsion.

17. The self propelled conveyance of claim 16, further comprising:
a steering wheel adapted to steer the self propelled conveyance on land by controlling at least one wheel and further adapted to steer the self propelled conveyance in water by controlling an output of the water jets.
